(19) United States
(12) Patent Application Publication
(10) Pub. No.: US 2014/0023195 A1
(43) Pub. Date: Jan. 23, 2014

(54) RADIO FREQUENCY IDENTIFICATION (RFID) TAG, INTERROGATOR, AND METHOD FOR AUTHENTICATION BETWEEN THE RFID TAG AND THE INTERROGATOR

(71) Applicant: Electronics and Telecommunications Research Institute, Daejeon (KR)

(72) Inventors: Sang Yeoun LEE, Daejeon (KR); Joo Sang Park, Daejeon (KR); Kang Bok Lee, Daejeon (KR)

(21) Appl. No.: 13/946,484

(22) Filed: Jul. 19, 2013

(30) Foreign Application Priority Data
Jul. 23, 2012 (KR) 10-2012-0079911
Jun. 20, 2013 (KR) 10-2013-0070978

(51) Int. Cl. G06K 7/10; H04W 12/06

(52) U.S. Cl. CPC G06K 7/10257; H04W 12/06
USPC 380/270

(57) ABSTRACT

Provided is a method for authentication between a radio frequency identification (RFID) tag and an interrogator configured to communicate with the RFID tag. An authentication method performed by the interrogator may include: transmitting, to an RFID tag, a challenge command comprising random interrogator information for initializing an encryption engine and challenge interrogator information for authenticating the RFID tag; receiving, from the RFID tag, random tag information, encrypted challenge tag information, and encrypted tag authentication data; initializing the encryption engine based on the random to interrogator information and the random tag information; decrypting the encrypted challenge tag information and the encrypted tag authentication data; and authenticating the RFID tag based on the decrypted challenge tag information, the decrypted tag authentication data, and the challenge interrogator information.

### CROSS-REFERENCE TO RELATED APPLICATIONS

This application claims the priority benefit of Korean Patent Application No. 10-2012-0079911, filed on Jul. 23, 2012, and Korean Patent Application No. 10-2013-0070978, filed on Jun. 20, 2013, in the Korean Intellectual Property Office, the disclosures of which are incorporated herein by reference.

### BACKGROUND

1. Field of the Invention

The following description relates to a method for authentication between a radio frequency identification (RFID) tag and an interrogator configured to communicate with the RFID tag.

2. Description of the Related Art

With the development of a radio frequency identification (RFID) technology, a variety of technologies are being applied to an RFID system. The RFID system may include an RFID tag and an interrogator configured to communicate with the RFID tag. For example, the interrogator may include an RFID reader.

Currently, in response to a security being recognized to be important, a technology for applying a security function to communication between an interrogator and an RFID tag is continuously developed even in the RFID system. An authentication procedure between an RFID reader and an RFID tag, including RFID tag authentication, RFID reader authentication, and mutual authentication, may use a relatively large amount of time to drive an encryption engine due to limited sources of the RFID tag, such as clock, memory, register, and power. Accordingly, the RFID reader may use a large amount of time to recognize a plurality of RFID tags.

To decrease an amount of time used to recognize an RFID tag, EPCglobal Gen2 V2.0 proposes use of a challenge command and describes that an operation method needs to follow each encryption scheme.

### SUMMARY

According to an aspect of one or more embodiments, there is provided an authentication method performed by an interrogator, the method including: transmitting, to a radio frequency identification (RFID) tag, a challenge command including random to interrogator information for initializing an encryption engine and challenge interrogator information for authenticating the RFID tag; receiving, from the RFID tag, random tag information, encrypted challenge tag information, and encrypted tag authentication data; initializing the encryption engine based on the random interrogator information and the random tag information; decrypting the encrypted challenge tag information and the encrypted tag authentication data; and authenticating the RFID tag based on the decrypted challenge tag information, the decrypted tag authentication data, and the challenge interrogator information.

The authentication method performed by the interrogator may further include re-encrypting the decrypted challenge tag information and transmitting the re-encrypted challenge tag information to the RFID tag when authentication of the RFID tag is determined as a success.

The authentication method performed by the interrogator may further include receiving, from the RFID tag, protocol control (PC) information, an XPC_W1 parameter, an XPC_W2 parameter, and unique item identifier (UII) information.

According to another aspect of one or more embodiments, there is provided an authentication method performed by a radio frequency identification (RFID) tag, the method including: receiving, from an interrogator, a challenge command including random interrogator information for initializing an encryption engine and challenge interrogator information for authenticating the RFID tag; generating random tag information for initializing the encryption engine and challenge tag information for authenticating the interrogator; initializing the encryption engine based on the random interrogator information and the random tag information; generating tag authenticating data based on the challenge interrogator information and the challenge tag information; encrypting the challenge tag information and the tag authentication data; transmitting, to the interrogator, the random tag information, the encrypted challenge tag information, and the encrypted tag authentication; and authenticating the interrogator by decrypting re-encrypted challenge tag information that is received from the interrogator, and by comparing the decrypted challenge tag information and challenge tag information generated by the RFID tag.

The authentication method performed by the RFID tag may further include transmitting, to the interrogator, PC information, an XPC_W1 parameter, an XPC_W2 parameter, and UII information.

According to still another aspect of one or more embodiments, there is provided an authentication method performed by an interrogator, the method including: transmitting, to an RFID tag, a first challenge command including random interrogator information for initializing an encryption engine and a second challenge command including challenge interrogator information for authenticating the RFID tag; receiving, from the RFID tag, random tag information, encrypted challenge tag information, and encrypted tag authentication data; initializing the encryption engine based on the random interrogator information and the random tag information; decrypting the encrypted challenge tag information and the encrypted tag authentication data; and authenticating the RFID tag based on the decrypted challenge tag information, the decrypted tag authentication data, and the challenge interrogator information.

The authentication method performed by the interrogator may further include re-encrypting the decrypted challenge tag information, and transmitting the re-encrypted challenge tag information to the RFID tag when authentication of the RFID tag is determined as a success.

According to yet another aspect of one or more embodiments, there is provided an authentication method performed by a radio frequency identification (RFID) tag, the method including: receiving, from an interrogator, a first challenge command including random interrogator information for initializing an encryption engine and a second challenge command including challenge interrogator information for authenticating the RFID tag; to generating random tag information for initializing the encryption engine and challenge tag information for authenticating the interrogator; initializing the encryption engine based on the random interrogator information and the random tag information; generating tag authentication data based on the challenge interrogator information and the challenge tag information; encrypting the challenge tag information and the tag authentication data; transmitting, to the interrogator, the random tag information, the encrypted challenge tag information, and the encrypted tag authentication data; and authenticating the interrogator by decrypting the re-encrypted challenge tag information received from the interrogator, and by comparing the decrypted challenge tag information and the challenge tag information generated by the RFID tag.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a radio frequency identification (RFID) system including an interrogator and an RFID tag according to an embodiment;

FIG. 2 is a diagram to describe a mutual authentication method between an interrogator and an RFID tag according to an embodiment;

FIGS. 3 and 4 are diagrams to describe examples of configuring mutual authentication between an interrogator and an RFID tag according to an embodiment;

FIG. 5 is a block diagram illustrating a configuration of an interrogator according to an embodiment;

FIG. 6 is a block diagram illustrating a configuration of an RFID tag according to an embodiment;

FIG. 7 is a flowchart illustrating an authentication method performed by an interrogator according to an embodiment; and

FIG. 8 is a flowchart illustrating an authentication method performed by an RFID tag according to an embodiment.

### DETAILED DESCRIPTION

Reference will now be made in detail to exemplary embodiments, examples of which are illustrated in the accompanying drawings, wherein like reference numerals refer to the like elements throughout. Exemplary embodiments are described below to explain the present invention by referring to the figures.

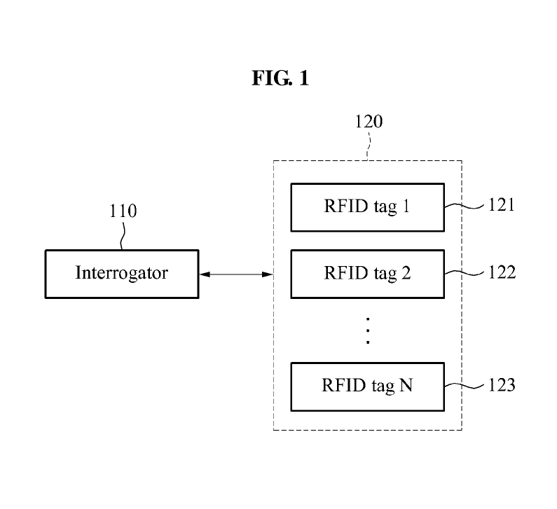

FIG. 1 is a diagram illustrating a radio frequency identification (RFID) system including an interrogator 110 and an RFID tag 120 according to an embodiment. For example, the interrogator 110 may include an RFID reader.

Referring to FIG. 1, the interrogator 110 may control RFID tags 120 including an RFID tag (1) 121, an RFID tag (2) 122, . . . , an RFID tag (3) 123, through communication with the RFID tags 120. The interrogator 110 may perform a procedure of authenticating the RFID tags 120 in order to communicate with the RFID tags 120. Each of the RFID tags 120 may perform a procedure of authenticating the interrogator 110.

The interrogator 110 may access resources of the RFID tags 120 through an authentication procedure with the RFID tags 120. The interrogator 110 may decrease an amount of time used for the authentication procedure by simultaneously performing the authentication procedure and an initialization procedure of an encryption engine between the interrogator 110 and the RFID tags 120 using a challenge command. The challenge command may include information used for initializing the encryption engine and information used for performing the authentication procedure. For example, the interrogator 110 may transmit the challenge command at a start point in time of an inventory to the RFID tags 120 and thereby control an operation of the RFID tags 120 to perform an operation associated with authentication in advance. In response to the challenge command received from the interrogator 110, the RFID tags 120 may perform the operation associated with the authentication in advance, thereby decreasing an amount of time used for the authentication procedure between the interrogator 110 and the RFID tags 120. When the authentication between the interrogator 110 and the RFID tags 120 succeeds, a security channel may be formed between the interrogator 110 and each of the RFID tags 120.

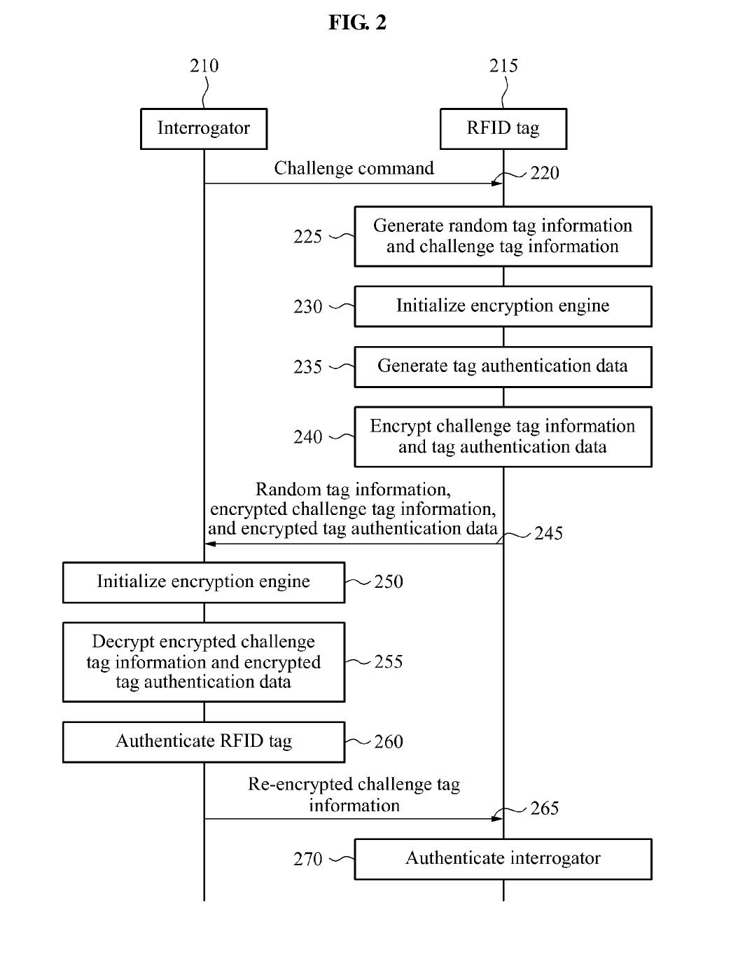

FIG. 2 is a diagram to describe a mutual authentication method between an interrogator 210 and an RFID tag 215 according to an embodiment.

Referring to FIG. 2, in operation 220, the interrogator 210 may transmit a challenge command to the RFID tag 215. The interrogator 210 may control a plurality of RFID tags 215 to be independent and simultaneously perform in advance an operation associated with an authentication through the challenge command. For example, when the RFID tag 215 receives the challenge command from the interrogator 210, the RFID tag 215 may pre-calculate a cryptographic value used for an authentication procedure and may store the calculated cryptographic value. The RFID tag 215 may not reply to the challenge command of the interrogator 210.

For example, a format of the challenge command may be expressed as shown in the following Table 1.

TABLE 1

| | | | | | Crypto | | | |
|---|---|---|---|---|---|---|---|---|
| | | | | | Suite | | | CRC- |
| | Command | RFU | IncRepLen | Immed | ID | Length | Message | 16 |
| # of bits | 8 | 2 | 1 | 1 | 10 | 12 | Variable | 16 |
| description | 11010100 | 00 | 0: Omit | 0: Do not | CSI | length | message | CRC- |
| | | | length | transmit | | of | (depends | 16 |
| | | | from reply | result with | | message | on CSI) | |
| | | | 1: Include | UII | | | | |
| | | | length in | 1: Transmit | | | | |
| | | | reply | result with | | | | |
| | | | | UII | | | | |

According to Table 1, the challenge command may include an IncRepLen field, an Immed field, a Crypto Suite ID (CSI) field, a Length field, and a Message field. The IncRepLen field may indicate whether the RFID tag 215 includes length information within a reply. For example, when a value of the IncRepLen field is “0”, it may indicate that the RFID tag 215 does not include length information in the reply. When a value of the IncRepLen field is “1”, it may indicate that the RFID tag 215 includes length information in the reply. The Immed field may indicate whether to associate a result of the challenge command with a unique item identifier (UII) of the RFID tag 215 when the interrogator 210 responds to an acknowledge (ACK) signal. For example, when a value of the Immed field is “0”, it may indicate that the RFID tag 215 transmits only an UII to the interrogator 210 in response to the ACK signal of the interrogator 210. When a value of the Immed field is “1”, it may indicate that the RFID tag 215 transmits the UII and the result of the challenge command to the interrogator 210 in response to the ACK signal of the interrogator 210. A cryptographic suite used by the RFID tag 215 and the interrogator 210 may be selected through the CSI field. The Message field may include parameters used for authentication, and the Length field may indicate a length of the Message field using a bit value.

The Message field of the challenge command may be expressed as shown in the following Table 2.

TABLE 2

| | RnLen | ChLen | RnInt | ChInt |
|---|---|---|---|---|
| # of bits | 4 | 4 | 64 | 16*n |
| description | Word | Word | Random | Random |
| | number | number | number | Challenge |
| | of RnInt | of ChInt | | |

The Message field may include random interrogator information (RnInt), challenge interrogator information (ChInt), a length of the random interrogator information (RnLen), and a length of the challenge interrogator (ChLen). The random interrogator information and the challenge interrogator information may be randomly generated. The random interrogator information and the length of random interrogator information may be used to initialize an encryption engine. The challenge interrogator information and the length of challenge interrogator information may be used to authenticate the RFID tag 215 during a mutual authentication procedure between the interrogator 210 and the RFID tag 215. The interrogator 210 may initialize an encryption engine in response to a challenge command and may perform a first operation of an authentication procedure. The interrogator 210 may simultaneously perform the initialization process of the encryption engine and the authentication procedure between the interrogator 210 and the RFID tag 215 in response to the challenge command, thereby decreasing an amount of time used for the authentication procedure.

According to another embodiment, in operation 220, the interrogator 210 may separate the challenge command and thereby transmit the separate challenge command to the RFID tag 215. For example, the interrogator 210 may separate the challenge command into a first challenge command including random interrogator information for initializing the encryption engine and a second challenge command including challenge interrogator information for authenticating the RFID tag 215, and may transmit the first challenge command and the second challenge command to the RFID tag 215. The interrogator 210 may separate the challenge command into a plurality of challenge commands and thereby transmit the plurality of challenge commands separate from the challenge command, thereby decreasing a size of a challenge command message.

In operation 225, in response to the challenge command received from the interrogator 210, the RFID tag 215 may generate random tag information (RnTag) for initializing the encryption engine and challenge tag information (ChTag) for authenticating the interrogator 210. The random tag information and the challenge tag information may be randomly generated.

According to another embodiment, in operation 225, the RFID tag 215 may receive, from the interrogator 210, a first challenge command including random interrogator information for initializing the encryption engine and a second challenge command including challenge interrogator information for authenticating the RFID tag 215. In response to the first challenge command and the second challenge command, the RFID tag 215 may generate random tag information for initializing the encryption engine and challenge tag information for authenticating the interrogator 210.

In operation 230, the RFID tag 215 may initialize the encryption engine of the RFID tag 215 based on the random interrogator information and the random tag information. A process of initializing the encryption engine may correspond to a process of synchronizing the encryption engine of the interrogator 210 and the encryption engine of the RFID tag 215. A key and a predetermined input stream may be used for the initialization process of the encryption engine. The RFID tag 215 may initialize the encryption engine using the key stored in the memory, the random interrogator information generated by the interrogator 210, and the random tag information.

In operation 235, the RFID tag 215 may generate tag authentication data (AuthData) based on the challenge interrogator information and the challenge tag information. For to example, the RFID tag 215 may generate tag authentication data by performing an exclusive-OR (XOR) operation on the challenge interrogator information and the challenge tag information.

In operation 240, the RFID tag 215 may encrypt the challenge tag information and the tag authentication data. The RFID tag 215 may store the encrypted challenge tag information and the encrypted tag authentication data in a buffer. The RFID tag 215 may store, in the buffer, information about the key stored in the memory (or a database) and the random tag information generated in operation 225 together with the encrypted challenge tag information and the encrypted tag authentication data.

In operation 245, the RFID tag 215 may transmit, to the interrogator 210, the random tag information, the encrypted challenge tag information, and the encrypted tag authentication data. The RFID tag 215 may determine a transmission point in time of data based on an Immed field value included in the challenge command. In response to an ACK signal or a ReadBuffer command transmitted from the interrogator 210, the RFID tag 215 may transmit, to the interrogator 210, the random tag information, the encrypted challenge tag information (enc(ChTag)), and the encrypted tag authentication data (enc(AuthData)) based on the Immed field value. For example, when the Immed field value is “1”, the RFID tag 215 may transmit, to the interrogator 210, the random tag information, the encrypted challenge tag information, and the encrypted tag authentication data in response to the ACK signal transmitted from the interrogator 210. When the Immed field value is “0, the RFID tag 215 may transmit, to the interrogator 210, the random tag information, the encrypted challenge tag information, and the encrypted tag authentication data in response to the ReadBuffer command transmitted from the interrogator 210. When the Immed field value is 0, the RFID tag 215 may store the random tag information, the encrypted challenge tag information, and the encrypted tag authentication data in the buffer during an inventory procedure and then transmit data stored in the buffer, to the interrogator 210 in response to the ReadBuffer.

When the random tag information, the encrypted challenge tag information, and the encrypted tag authentication data are received from the RFID tag 215, the interrogator 210 may initialize the encryption engine of the interrogator 210 based on the random interrogator information and the random tag information in operation 250. The interrogator 210 may initialize the encryption engine based on a key read from a memory (or a database), the random interrogator information, and the random tag information generated by the RFID tag 215. In operation 255, the interrogator 210 may decrypt the encrypted challenge tag information and the encrypted tag authentication data.

In operation 260, the interrogator 210 may authenticate the RFID tag 215 based on the decrypted challenge tag information, the decrypted tag authentication data, and the challenge interrogator information. The interrogator 210 may generate another authentication data based on the challenge interrogator information and the decrypted challenge tag information, and may authenticate the RFID tag 215 by comparing the generated authentication data and the decrypted tag authentication data. For example, the interrogator 210 may generate authentication data by performing an XOR operation on the decrypted challenge tag information and the challenge interrogator information. When the generated authentication data is identical to the decrypted tag authentication data, the interrogator 210 may determine that authentication of the RFID tag 215 is a success. Conversely, when the generated authentication data differs from the decrypted tag authentication data, the interrogator 210 may determine that the authentication of the RFID tag 215 is a failure.

Through the aforementioned process, the interrogator 210 may authenticate the RFID tag 215.

After the inventory procedure, the interrogator 210 may induce a mutual authentication procedure performed by the RFID tag 215 through an Authenticate command. For example, when the authentication of the RFID tag 215 is determined as a success, the interrogator 210 may transmit the Authenticate command to the RFID tag 215. The interrogator 210 may re-encrypt the decrypted challenge tag information, and may transmit the re-encrypted challenge tag information (enc(ChTag)) to the RFID tag 215 through the Authenticate command. The Authenticate command may include the re-encrypted challenge tag information.

When the re-encrypted challenge tag information is received from the interrogator 210, the RFID tag 215 may perform an authentication procedure on the interrogator 210, based on the re-encrypted challenge tag information in operation 270. The RFID tag 215 may perform the authentication procedure on the interrogator 210 by decrypting the re-encrypted challenge tag information and by comparing the decrypted challenge tag information and the challenge tag information generated in operation 225.

When it is determined that the decrypted challenge tag information is identical to the challenge tag information generated in operation 225, the RFID tag 215 may determine that the authentication of the interrogator 210 is a success. Conversely, when it is determined that the decrypted challenge tag information differs from the challenge tag information generated in operation 225, the RFID tag 215 may determine that the authentication of the interrogator 210 is a failure.

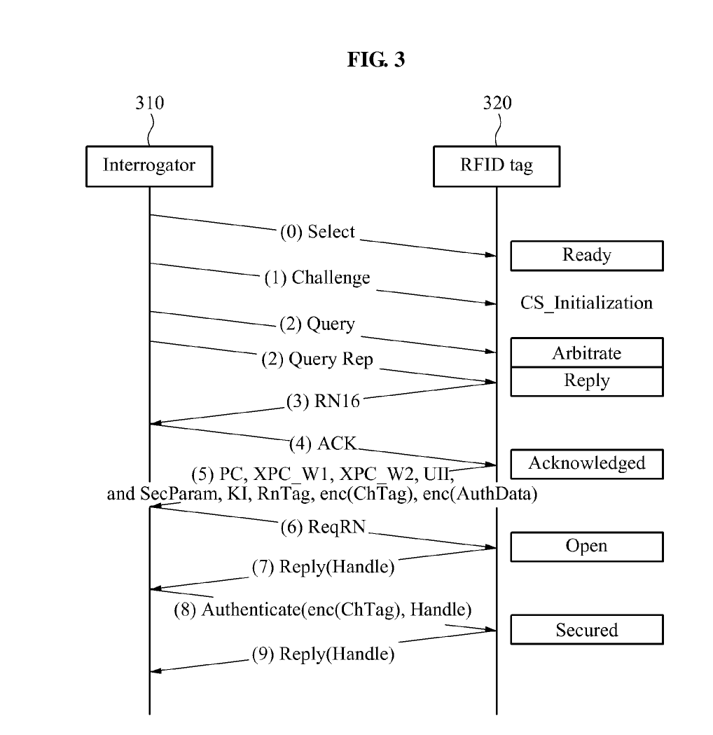

FIGS. 3 and 4 are diagrams to describe examples of configuring mutual authentication between an interrogator and an RFID tag according to an embodiment. FIG. 3 illustrates an example in which an Immed field value of a challenge command is “1”, and FIG. 4 illustrates an example in which an Immed field value of a challenge command is “0”.

Referring to FIGS. 3 and 4, interrogators 310 and 410 may transmit a challenge command to RFID tags 320 and 420 only once, or may separate the challenge command into a plurality of commands and thereby transmit the plurality of commands to the RFID tags 320 and 420. For example, the interrogators 310 and 420 may transmit a single challenge command including all of random interrogator information for initializing an encryption engine and challenge interrogator information for authenticating the RFID tags 320 and 420, or may separate the challenge command into a first challenge command including random interrogator information and a second challenge interrogator command including challenge interrogator information and thereby transmit the first challenge command and the second challenge command.

For example, when the interrogators 310 and 410 transmit a single challenge command, a Message field may be expressed as shown in the following Table 3. When the interrogators 310 and 410 separate the challenge command into the first challenge command and the second challenge command and thereby transmit the first challenge command and the second challenge command, a Message field (upper table) included in the first challenge command and a Message field (lower table) included in the second challenge command may be expressed as shown in the following Table 4.

TABLE 3

| RnLen | ChLen | RnInt | ChInt |
|---|---|---|---|
| 0100 | 0100 | 16*RnLen | 16*ChLen |

TABLE 4

| RnLen | ChLen | RnInt |
|---|---|---|
| 0100 | 0000 | 16*RnLen |
| RnLen | ChLen | ChInt |
| 0000 | 0100 | 16*ChLen |

Referring to FIGS. 3 and 4, in response to an ACK signal transmitted from the interrogators 310 and 410, the RFID tags 320 and 420 may transmit protocol control (PC) information, an XPC_W1 parameter, an XPC_W2 parameter, and UR information to the interrogators 310 and 410. The UR information may be identification information of the RFID tags 320 and 420. The XPC_W1 parameter may include RFID tag identification information used to identify a general RFID tag and a secure RFID tag. The XPC_W2 parameter may include information associated with RFID tag authentication, interrogator to authentication, and mutual authentication.

As illustrated in FIG. 3, when an Immed field value is “1”, the RFID tag 320 may transmit, to the interrogator 310, the UII and data stored in a buffer during an inventory procedure. In response to an ACK signal transmitted from the interrogator 310, the RFID tag 320 may transmit, to the interrogator 310, random tag information, encrypted challenge tag information, and encrypted authentication data together with the UR.

As illustrated in FIG. 4, when an Immed field value is “0”, the RFID tag 420 may transmit, to the interrogator 410, data stored in the buffer through a ReadBuffer command received from the interrogator 410. In response to the ReadBuffer command, the RFID tag 420 may transmit, to the interrogator 410, random tag information, encrypted challenge tag information, and encrypted authentication data.

In FIGS. 3 and 4, in order to access resources of the RFID tags 320 and 420 after performing authentication of the RFID tags 320 and 420, the interrogators 310 and 410 may transmit an Authenticate command to the RFID tags 320 and 420, thereby inducing an authentication procedure to be performed by the RFID tags 320 and 420. For example, the authentication procedure transmitted after the inventory procedure may be expressed as shown in the following Table 5. The Authenticate command may include re-encrypted challenge tag information (Enc(ChTag)).

TABLE 5

| Auth.Method | Step | Flags | ChLen | Enc(ChTag) |
|---|---|---|---|---|
| 010 | 01 | RFU | 0100 | 16*ChLen |

The interrogators 310 and 410 may decrypt the encrypted challenge tag information that is received from the RFID tags 320 and 420 and re-encrypt the decrypted challenge tag information and then transmit the re-encrypted challenge tag information to the RFID tags 320 and 420. When the re-encrypted challenge tag information is received, the RFID tags 320 and 420 may perform the authentication procedure of the interrogators 310 and 410 by decrypting the re-encrypted challenge tag information and by comparing the decrypted challenge tag information and source challenge tag information. The interrogators 310 and 410 may include, in the challenge command, information for initialization an encryption engine and information for performing the authentication procedure, and may transmit the challenge command to the RFID tags 320 and 420, thereby decreasing an amount of time used for the authentication procedure during an inventory procedure between the interrogators 310 and 410 and the RFID tags 320 and 420. Since an amount of time used for the authentication procedure is reduced, the interrogators 310 and 410 may authenticate a relatively large number of RFID tags 320 and 420 for the same amount of time.

As the RFID tags 320 and 420 succeed in authenticating the interrogators 310 and 410, the RFID tags 320 and 420 may insert a handle parameter in a reply message as a response to the Authenticate command and may transmit the reply message to the interrogators 310 and 410. When the RFID tags 320 and 420 fail in authenticating the interrogators 310 and 410, the RFID tags 320 and 420 may not transmit the reply message to the interrogators 310 and 410 as a response to the Authenticate command.

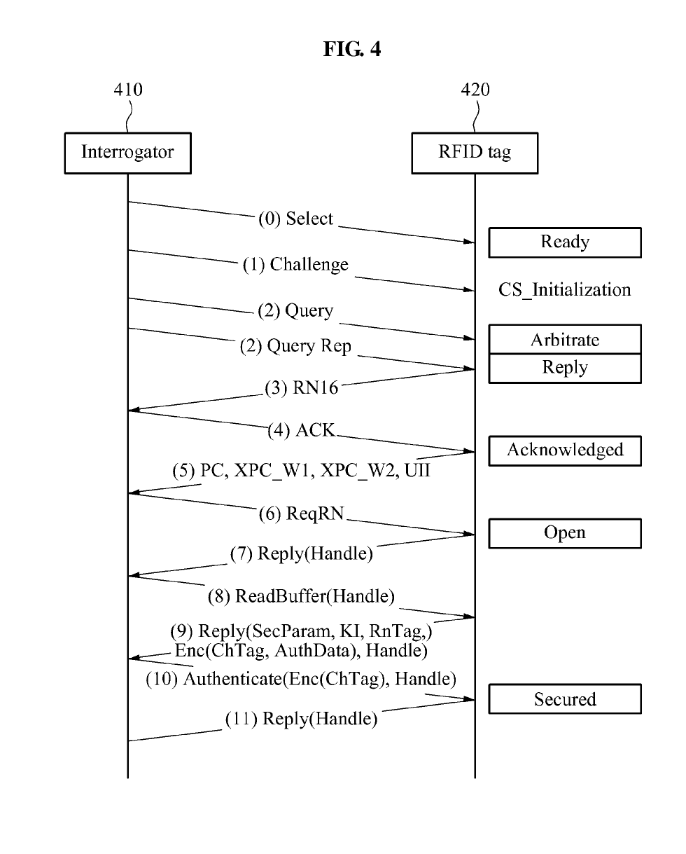

FIG. 5 is a block diagram illustrating a configuration of an interrogator 510 according to an embodiment.

Referring to FIG. 5, the interrogator 510 may include a challenge command generator 520, an authenticator 530, and a communicator 540.

The challenge command generator 520 may generate a challenge command to be transmitted to an RFID tag. The challenge command may include an IncRepLen field, Immed field, a CSI field, a Length field, and a Message field. The Message field may include random interrogator information (RnInt), challenge interrogator information (ChInt), a length of random interrogator information (RnLen), and a length of challenge interrogator information (ChLen). The random interrogator information and the challenge interrogator information may be randomly generated. The random interrogator information and the length of random interrogator information may be used to initialize an encryption engine. The challenge interrogator information and the length of challenge interrogator information may be used for a mutual authentication procedure between the interrogator 510 and the RFID tag and for authenticating the RFID tag. The communicator 540 may transmit the generated challenge command to the RFID tag.

According to another embodiment, the challenge command generator 520 may generate the challenge command by separating the challenge command into a plurality of commands. For example, the challenge command generator 520 may generate a first challenge command including random interrogator information for initializing the encryption engine and a second challenge command including challenge interrogator information for authenticating the RFID tag. The communicator 540 may transmit the first challenge command and the second challenge command to the RFID tag.

The communicator 540 may receive, from the RFID tag, random tag information, encrypted challenge tag information, and encrypted tag authentication data. The authenticator 530 may initialize the encryption engine based on the random interrogator information and the random tag information received from the RFID tag. The authenticator 530 may decrypt the encrypted challenge tag information and the encrypted tag to authentication data that are received from the RFID tag. The authenticator 530 may authenticate the RFID tag based on the decrypted challenge tag information, the decrypted tag authentication data, and the challenge interrogator information. The authenticator 530 may generate another set of authentication data based on the challenge interrogator information and the decrypted challenge tag information, and may authenticate the RFID tag by comparing the generated authentication data and the decrypted tag authentication data. When the generated authentication data is identical to the decrypted tag authentication data, the authenticator 530 may determine that authentication of the RFID tag is a success. When authentication of the RFID tag is determined as a success, the authenticator 530 may re-encrypt the decrypted challenge tag information for mutual authentication between the interrogator 510 and the RFID tag. The communicator 540 may transmit the re-encrypted challenge tag information to the RFID tag.

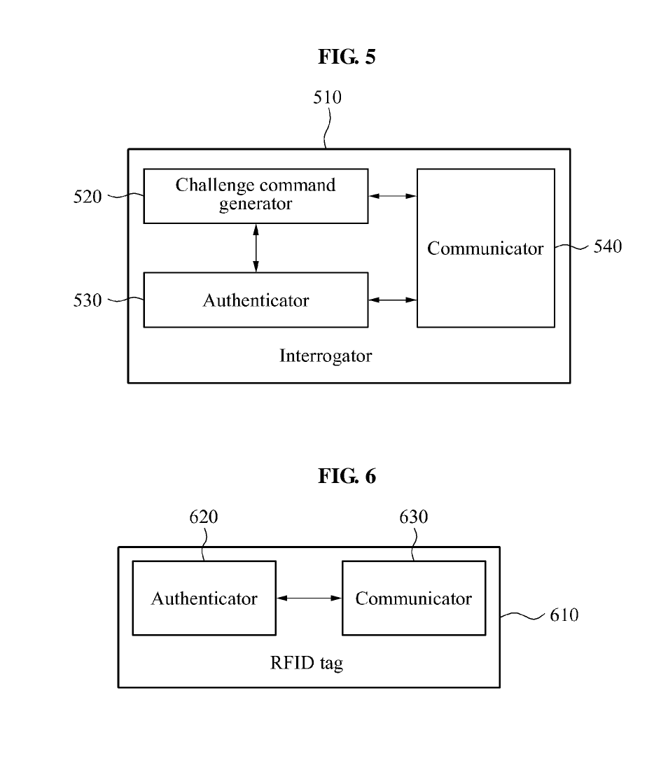

FIG. 6 is a block diagram illustrating a configuration of an RFID tag 610 according to an embodiment.

Referring to FIG. 6, the RFID tag 610 may include an authenticator 620 and a communicator 630.

The communicator 630 may receive, from an interrogator, a challenge command including random interrogator information for initializing an encryption engine and challenge interrogator information for authenticating the RFID tag 610.

The authenticator 620 may generate random tag information for initializing the encryption engine and challenge tag information for authenticating the interrogator. The random tag information and the challenge tag information may be randomly generated. The authenticator 620 may initialize the encryption engine based on the random tag information and the random interrogator information received from the interrogator. The authenticator 620 may generate tag authentication data based on the challenge tag information and the challenge interrogator information received from the interrogator. The authenticator 620 may encrypt the challenge tag information and the tag authentication data.

The communicator 630 may transmit, to the interrogator, the random tag information, the encrypted challenge tag information, and the encrypted tag authentication data. The communicator 630 may transmit a transmission point in time of the random tag information, the encrypted challenge tag information, and the encrypted tag authentication data, based on a bit value of an Immed field included in the challenge command. The communicator 630 may receive, from the interrogator, challenge tag information re-encrypted by the interrogator.

When the re-encrypted challenge tag information is received, the authenticator 620 may authenticate the interrogator by decrypting the re-encrypted challenge tag information, and by comparing the decrypted challenge tag information and source challenge tag information that is the challenge tag information generated by the authenticator 620. When the decrypted challenge tag information is identical to the source challenge tag information, the authenticator 620 may determine that the authentication of the interrogator is a success.

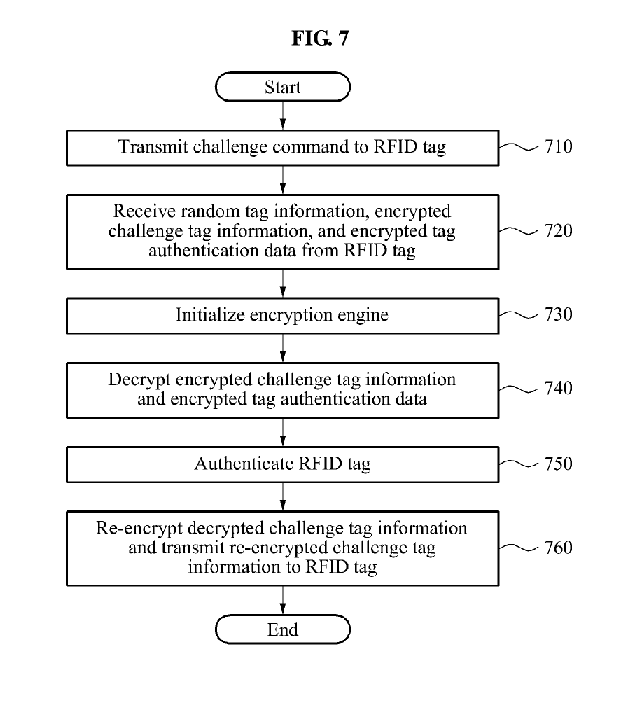

FIG. 7 is a flowchart illustrating an authentication method performed by an interrogator according to an embodiment.

In operation 710, the interrogator may generate a challenge command to be transmitted to an RFID tag. The challenge command may include random interrogator information for initializing an encryption engine and challenge interrogator information for authenticating the RFID tag. The random interrogator information and the challenge interrogator information may be randomly generated. The interrogator may transmit the generated challenge command to the RFID tag.

According to another exemplary embodiment, the interrogator may separate and thereby generate the challenge command. The interrogator may generate a first challenge command including random interrogator information for initializing the encryption engine and a second challenge command including challenge interrogator information for initializing the RFID tag. The interrogator may transmit the generated first challenge command and second challenge command to the RFID tag.

In operation 720, the interrogator may receive random tag information, encrypted challenge tag information, and encrypted tag authentication data from the RFID tag. In operation 730, the interrogator may initialize the encryption engine based on the random interrogator information and the random tag information received from the RFID tag. In operation 740, the interrogator may decrypt the encrypted challenge tag information and the encrypted tag authentication data that are received from the RFID tag.

In operation 750, the interrogator may authenticate the RFID tag based on the decrypted challenge tag information, the decrypted tag authentication data, and the challenge interrogator information. The interrogator may generate another set of authentication data based on the challenge interrogator information and the decrypted challenge tag information, and may authenticate the RFID tag by comparing the generated authentication data and the decrypted tag authentication data. When the generated authentication data is identical to the decrypted tag authentication data, the interrogator may determine that the authentication of the generated RFID tag is a success.

In operation 760, when the authentication of the RFID tag is determined as a success, the interrogator may re-encrypt the decrypted challenge tag information for mutual authentication between the interrogator and the RFID tag, and may transmit the re-encrypted challenge tag information to the RFID tag.

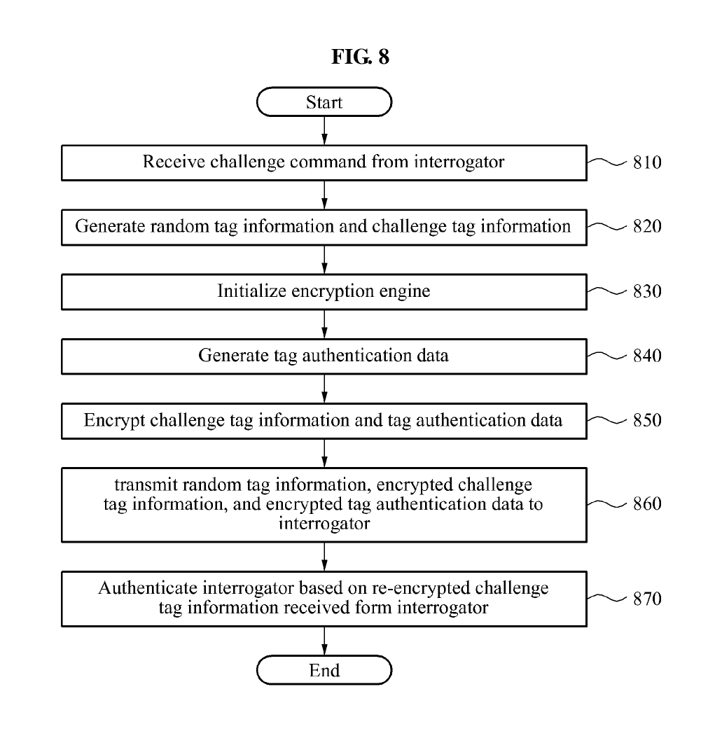

FIG. 8 is a flowchart illustrating an authentication method performed by an RFID tag according to an embodiment.

In operation 810, the RFID tag may receive, from an interrogator, a challenge command including random interrogator information for initializing an encryption engine and challenge interrogator information for authenticating the RFID tag.

In operation 820, the RFID tag may generate random tag information for initializing the encryption engine and challenge tag information for authenticating the interrogator. The random tag information and the challenge tag information may be randomly generated. In operation 830, the RFID tag may initialize the encryption engine based on the random tag information and the random interrogator information received from the interrogator.

In operation 840, the RFID tag may generate tag authentication data based on the challenge tag information and the challenge interrogator information received from the interrogator. In operation 850, the RFID tag may encrypt the challenge tag information and the tag authentication data.

In operation 860, the RFID tag may transmit the random tag information, the encrypted challenge tag information, and the encrypted tag authentication data to the interrogator. The RFID tag may determine a transmission point in time of the random tag information, the encrypted challenge tag information, and the encrypted tag authentication data, based on a bit value of an Immed field included in the challenge command.

When the re-encrypted challenge tag information is received from the interrogator, the RFID tag may decrypt the re-encrypted challenge tag information in operation 870. The RFID tag may authenticate the interrogator by comparing the decrypted challenge tag information and the challenge tag information generated in operation 820. When the decrypted challenge tag information is identical to the challenge tag information generated in operation 820, the RFID tag may determine that the authentication of the interrogator is a success.

The above-described exemplary embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks and DVDs; magneto-optical media such as floptical disks; and hardware devices that are specially configured to store and perform to program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments, or vice versa.

Although a few exemplary embodiments have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A radio frequency identification (RFID) tag authentication method performed by an interrogator, the method comprising:
transmitting, to an RFID tag, a challenge command comprising random interrogator information for initializing an encryption engine and challenge interrogator information for authenticating the RFID tag;
receiving, from the RFID tag, random tag information, encrypted challenge tag information, and encrypted tag authentication data;
initializing the encryption engine based on the random interrogator information and to the random tag information;
decrypting the encrypted challenge tag information and the encrypted tag authentication data; and
authenticating the RFID tag based on the decrypted challenge tag information, the decrypted tag authentication data, and the challenge interrogator information.

2. The method of claim 1, further comprising:
re-encrypting the decrypted challenge tag information and transmitting the re-encrypted challenge tag information to the RFID tag after an inventory procedure when authentication of the RFID tag is determined as a success.

3. The method of claim 1, wherein the authenticating of the RFID tag comprises:
generating authentication data based on the challenge interrogator information and the decrypted challenge tag information; and
authenticating the RFID tag by comparing the generated authentication data and the decrypted tag authentication data.

4. The method of claim 3, wherein the generating of the authentication data comprises:
generating the authentication data by performing an exclusive-OR (XOR) operation on the decrypted challenge tag information and the challenge interrogator information.

5. The method of claim 3, wherein the authenticating of the RFID tag comprises determining that the authentication of the RFID tag is a success when the generated authentication data is identical to the decrypted tag authentication data.

6. The method of claim 1, wherein the challenge command comprises the random interrogator information, a length of the random interrogator information, the challenge interrogator information, and a length of the challenge interrogator information.

7. The method of claim 1, wherein the random interrogator information and challenge interrogator information are randomly generated.

8. An interrogator authentication method performed by a radio frequency identification (RFID) tag, the method comprising:
receiving, from an interrogator, a challenge command comprising random interrogator information for initializing an encryption engine and challenge interrogator information for authenticating the RFID tag;
generating random tag information for initializing the encryption engine and challenge tag information for authenticating the interrogator;
initializing the encryption engine based on the random interrogator information and the random tag information;
generating tag authenticating data based on the challenge interrogator information and the challenge tag information;
encrypting the challenge tag information and the tag authentication data;
transmitting, to the interrogator, the random tag information, the encrypted challenge tag information, and the encrypted tag authentication; and
authenticating the interrogator by decrypting re-encrypted challenge tag information that is received from the interrogator after an inventory procedure, and by comparing the decrypted challenge tag information and the challenge tag information generated by the RFID tag.

9. The method of claim 8, wherein the transmitting comprises:
determining a transmission point in time of the random tag information, the encrypted challenge tag information, and the encrypted tag authentication data based on a bit value of an Immed field comprised in the challenge command.

10. The method of claim 9, wherein the transmitting comprises:
transmitting, to the interrogator during an inventory procedure, the random tag information, the encrypted challenge tag information, and the encrypted tag authentication data when the bit value of the Immed field is “1”; and
transmitting, to the interrogator after the inventory procedure, the random tag information, the encrypted challenge tag information, and the encrypted tag authentication data in response to a ReadBuffer command transmitted from the interrogator when the bit value of the Immed field is “0”.

11. The method of claim 8, wherein the generating of the tag authentication data comprises generating the tag authentication data by performing an exclusive-OR (XOR) operation on the challenge interrogator information and the challenge tag information.

12. The method of claim 8, wherein the authenticating of the interrogator comprises determining that the authentication is a success when the decrypted challenge tag information is identical to the challenge tag information generated by the RFID tag.

13. The method of claim 8, wherein the random tag information and the challenge tag information are randomly generated.

14. A mutual authentication method performed by an interrogator and a radio frequency identification (RFID) tag, the method comprising:
transmitting, by the interrogator to the RFID tag, a challenge command comprising random interrogator information for initializing an encryption engine and challenge interrogator information for authenticating the RFID tag;
generating, by the RFID tag, random tag information for initializing the encryption engine and challenge tag information for authenticating the interrogator;
initializing, by the RFID tag, the encryption engine based on the random tag information and the random interrogator information received from the interrogator;
generating, by the RFID tag, tag authentication data based on the challenge tag information and the challenge interrogator information received from the interrogator;
encrypting, by the RFID tag, the challenge tag information and the tag authentication data;
transmitting, by the RFID tag to the interrogator, the random tag information, the encrypted challenge tag information, and the encrypted tag authentication data;
initializing, by the interrogator, the encryption engine based on the random interrogator information and the random tag information received from the RFID tag;
decrypting, by the interrogator, the encrypted challenge tag information and the encrypted tag authentication data received from the RFID tag;
authenticating, by the interrogator, the RFID tag based on the decrypted challenge tag information, the decrypted tag authentication data, and the challenge interrogator information;
re-encrypting, by the interrogator, the decrypted challenge tag information, and transmitting the re-encrypted challenge tag information to the RFID tag after an inventory procedure; and
authenticating, by the RFID tag, the interrogator by decrypting the re-encrypted challenge tag information received from the interrogator, and by comparing the decrypted challenge tag information and the challenge tag information generated by the RFID tag.

15. A radio frequency identification (RFID) tag authentication method performed by an interrogator, the method comprising:
transmitting, to an RFID tag, a first challenge command comprising random interrogator information for initializing an encryption engine and a second challenge command comprising challenge interrogator information for authenticating the RFID tag;
receiving, from the RFID tag, random tag information, encrypted challenge tag information, and encrypted tag authentication data;
initializing the encryption engine based on the random interrogator information and the random tag information;
decrypting the encrypted challenge tag information and the encrypted tag authentication data; and
authenticating the RFID tag based on the decrypted challenge tag information, the decrypted tag authentication data, and the challenge interrogator information.

16. The method of claim 15, further comprising:
re-encrypting the decrypted challenge tag information, and transmitting the re-encrypted challenge tag information to the RFID tag after an inventory procedure when authentication of the RFID tag is determined as a success

17. An interrogator authentication method performed by a radio frequency identification (RFID) tag, the method comprising:
receiving, from an interrogator, a first challenge command comprising random interrogator information for initializing an encryption engine and a second challenge command comprising challenge interrogator information for authenticating the RFID tag;
generating random tag information for initializing the encryption engine and challenge tag information for authenticating the interrogator;
initializing the encryption engine based on the random interrogator information and the random tag information;
generating tag authentication data based on the challenge interrogator information and the challenge tag information;
encrypting the challenge tag information and the tag authentication data;
transmitting, to the interrogator, the random tag information, the encrypted challenge tag information, and the encrypted tag authentication data; and
authenticating the interrogator by decrypting the re-encrypted challenge tag information received from the interrogator after an inventory procedure, and by comparing the decrypted challenge tag information and the challenge tag information generated by the RFID tag.
